(19) United States
(12) Patent Application Publication
(10) Pub. No.: US 2009/0046035 A1
(43) Pub. Date: Feb. 19, 2009

(54) Notebook with mini-projector

(76) Inventor: Shu-Hui WEN, Taipei (TW)

Correspondence Address: SINORICA, LLC, 528 FALLSGROVE DRIVE, ROCKVILLE, MD, 20850, US

(21) Appl. No.: 12/029,921

(22) Filed: Feb. 12, 2008

(30) Foreign Application Priority Data
Aug. 16, 2007 (TW) 096130364

(51) Int. Cl. G09G 5/00

(52) U.S. Cl. 345/3.1

(57) ABSTRACT

A notebook with a mini-projector is disclosed. The notebook with a mini-projector includes a mainframe, a display and a mini-projector. The display is arranged on and is electrically connected with the mainframe while the mini-projector is disposed on top of the display. When the display is standing over the mainframe, an image is projected so that the convenience of use is enhanced.

### BACKGROUND OF THE INVENTION

The present invention relates to a notebook, especially to a notebook with a mini-projector.

A projector is commonly used in displaying photographs, movies and presentation data and is featured on that it can display the image onto a screen whose size is far more larger than a television or a monitor. Thus it is suitable to be applied to a large space with a lot of audience.

A conventional projector includes a light source, high-voltage lighting circuit and a heat dissipation system. The light source is a high-voltage halogen lamp, or a high intensity discharge lamp. Thus the projector has complicated structure that lead to large volume with higher power consumption. Thus it's possible for users to carry a projector with them. Therefore, the projector is set in a meeting room or in certain rooms.

The above projector is only suitable for being disposed in a large space. In a small room with only a few people, such projector is a kind of waste due to high power consumption and large space it requires.

Moreover, another shortcoming of the projector is low popularity due to large volume and high cost. Compare with other individual equipment such as PDA (personal digital assistant), PC (personal computer), notebooks, mobile discs or DVD players, the projector is costly and is not affordable to general users.

Furthermore, while performing a presentation in a meeting, most of people use a notebook in combination with a projector set in the meeting room. It takes time to set up connection between the notebook and the projector. This results in great inconvenience of the user.

Thus there is a need to provide a novel notebook with a mini-projector that user can perform presentation without restrictions of space and equipment. Moreover, projection angle of the mini-projector is adjustable by a rotation member. Furthermore, users can use the mini-projector or a video camera according to their demands

### SUMMARY OF THE INVENTION

Therefore it is a primary object of the present invention to provide a notebook with a mini-projector that increase the convenience of use of the notebook by disposition of the mini-projector.

It is another object of the present invention to provide a notebook with a mini-projector that the projection angle of the mini-projector is adjustable by rotation axes so as to provide better projection effect.

It is a further object of the present invention to provide a notebook with a mini-projector that includes a mini-projector and a video camera, being used depending on users' demands.

In order to achieve objects, a notebook with a mini-projector of the present invention includes a mainframe, a display and a mini-projector. The display is arranged on and is electrically connected with the mainframe while the mini-projector is disposed on top of the display for projecting an image.

The notebook with the mini-projector further includes a main housing, a mounting space and two rotation axes. The main housing is for disposition of the mini-projector while the mounting space for mounting the main housing is disposed on the display. The two axes are respectively arranged on two ends of the main housing, located between the main housing and the mounting space so as to enable the mini-projector rotatable for adjusting projection angle.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a perspective view of an embodiment according to the present invention;

FIG. 2 is an explosive view of part of an embodiment according to the present invention;

FIG. 3 is a schematic drawing showing action of an embodiment according to the present invention;

FIG. 4 is a schematic drawing of another embodiment according to the present invention;

FIG. 5 is a schematic drawing of a further embodiment according to the present invention;

FIG. 6 is a schematic drawing of a further embodiment according to the present invention;

FIG. 7 is a block diagram of an embodiment according to the present invention;

FIG. 8 is a block diagram of another embodiment according to the present invention.

### DETAILED DESCRIPTION OF THE PREFERRED EMBODIMENT

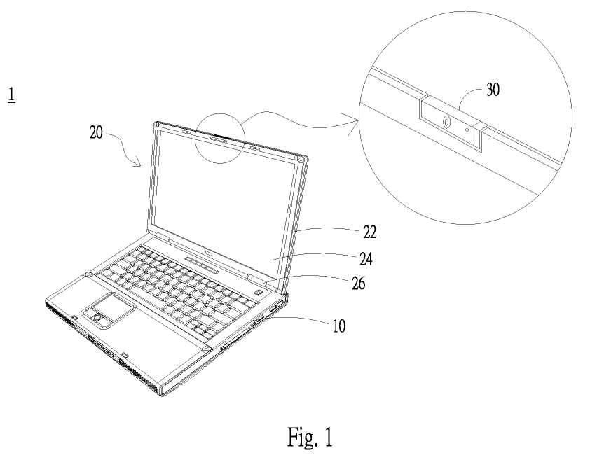

Refer to FIG. 1, a notebook 1 with a mini-projector according to the present invention consists of a mainframe 10, a display 20 and a mini-projector 30. The mainframe 10 is disposed under a keyboard 12 of the notebook 1. The display 20 is arranged over and is electrically connected with the mainframe 10. The display 20 includes a display housing 22 and a display module 24. The display housing 22 includes a connecting member 26 that connects with the mainframe 10 and locates between the display 20 and the mainframe 1 so that the display 20 is movable around the connecting member 26. The display module 24 is mounted inside the display housing 22 and is electrically connected with the mainframe 10 for displaying images. The mini-projector 30 is disposed on top of the display 20. It locates on the display housing 22 of the display 20, over the display module 24. Thus while using the notebook 1, a user can pull up the display 20, standing on the mainframe 10 by the connecting member 26 so that the mini-projector 30 can project images. Therefore, there is no need to use an extra projector once the user gets a notebook to report on a meeting.

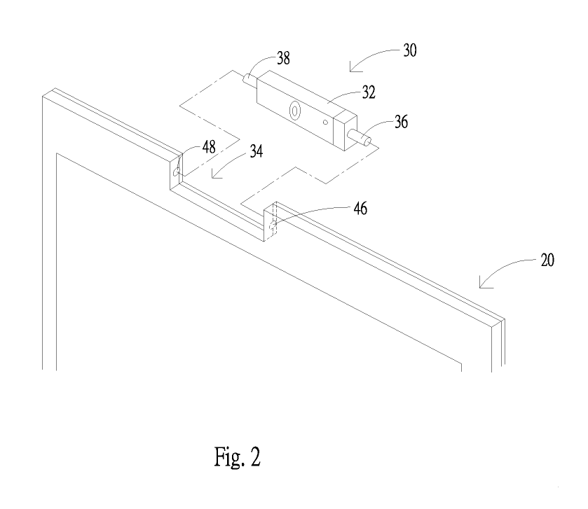

Refer to FIG. 2, the display 20 of the notebook 1 according to the present invention further includes a main housing 32, a mounting space 44 and two rotation axes 36, 38. The main housing 32 is for mounting and protecting the mini-projector 30 while the mounting space 44 is arranged on the display 20 and is located on top of the display 20 for accommodating the main housing 32. The two rotation axes 36, 38 respectively locate on two ends of the mini-projector 30. They can be disposed on the mini-projector 30 or on the main housing 32. There are two mounting holes 46, 48 arranged on right and left side walls of the mounting space 44, corresponding to the two rotation axes 36, 38 and the rotation two axes 36, 38 insert through the two mounting holes 46, 48. Thus the mini-projector 30 rotates around the two rotation axes 36, 38. The projection angle of the mini-projector 30 is adjustable according to user's needs so as to enhance projection effect. Moreover, the other way not shown in the FIG. 2 is that the two axes are disposed on right and left side walls of the mounting space 44 while the mounting holes are arranged on the main housing 32 of the mini-projector 30. Thus the two axes insert into the mounting holes on the mini-projector 30 while assembling the mini-projector 30 with the display 20.

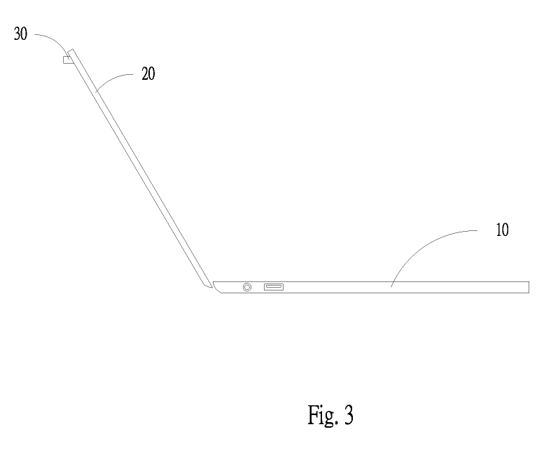

With reference to FIG. 3, users can rotate and adjust the mini-projector 30 by the two rotation axes 36, 38. Moreover, by the connecting member 26, the display 20 can cover on the mainframe 10 or is opened up. The angle between the display 20 and the mainframe 10 is adjustable. While the mini-projector 30 is adjusted and rotated upwards, the image is projected to a lower position. On the other hand, adjust the mini-projector 30 in reverse direction as well as angel between the display 20 and the mainframe 10, the projected position of the image is higher. The adjustment method mentioned above is applied depending on users needs.

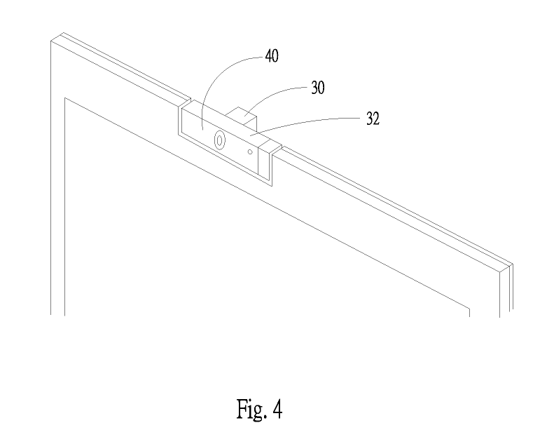

Refer to FIG. 4, a further embodiment is revealed. The difference between this embodiment and above embodiment is in that the present embodiment further includes a video camera 40 disposed on the display 20, on the side opposite to the mini-projector 30. When user intends to use the mini-projector 30, the main housing 32 is rotated so as to make the mini-projector 30 locate on the outer side of the display 20 for image projection. When user want to use the video camera 40, it is rotated to certain angle for photo shot. Therefore, the convenience of use is improved.

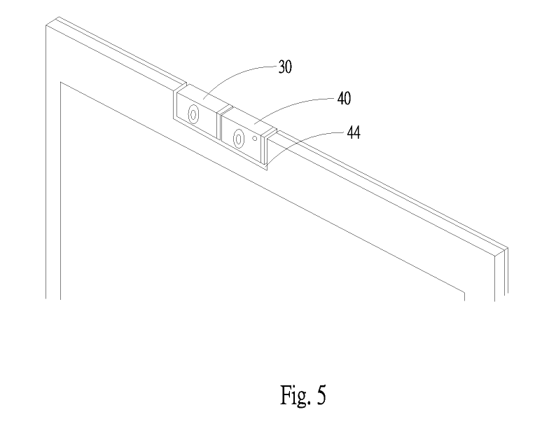

Refer to FIG. 5, the difference between this embodiment and the above one in FIG. 4 is in that the mini-projector 30 and the video camera 40 are arranged parallel inside the mounting space 44 of the display 20. A plurality sets of rotation axes (not shown in figure) is disposed between the mini-projector 30, the video camera 40 and two side walls of the mounting space 44. Thus the mini-projector 30 or the video camera 40 is used according to users requirements.

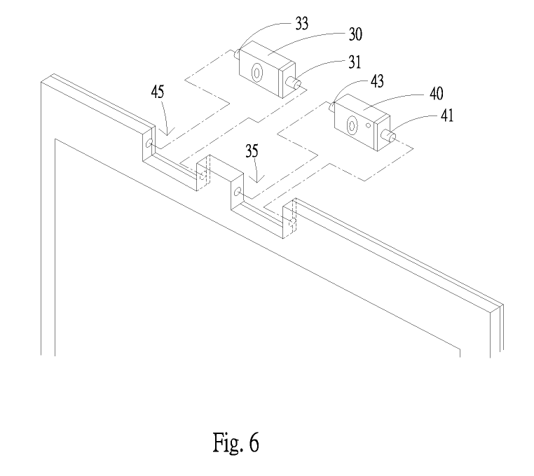

Refer to FIG. 6, the difference between this embodiment and the above one in FIG. 5 is in that this embodiment further includes a first mounting space 35 and a second mounting space 45 that are separated by a division plate 47. The first mounting space 35 and the second mounting space 45 respectively accommodate the video camera 40 and the mini-projector 30. A plurality of rotation axes 31, 33, 41, 43 are respectively disposed on two ends of the video camera 40 and the mini-projector 30. The rotation axes 41, 43 on two ends of the video camera 40 are mounted on right and left sides of the first mounting space 35 while the rotation axes 31, 33 on two ends of the mini-projector 30 are mounted on right and left sides of the second mounting space 45.

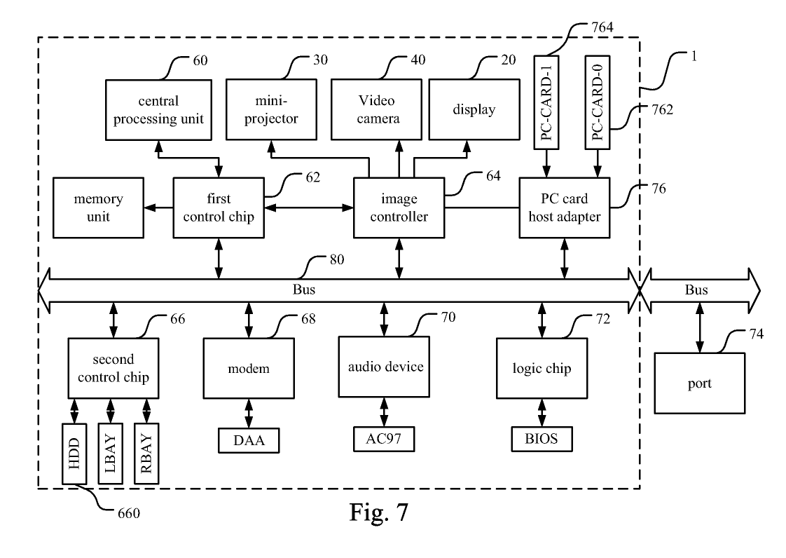

Refer to FIG. 7, a notebook 1 with a mini-projector of the present invention consists of a central processing unit 60, a first control chip 62, an image controller 64 and a mini-projector 30. While projecting images, the user enters a command through a keyboard of the notebook 1. After receiving the command, the central processing unit 60 generates a command signal that is sent to the first control chip 62, a northbridge chip. The first control chip 62 is coupled to a memory unit 63 for temporarily saving data. After receiving the command signal, the first control chip 62 produces a driving signal that is sent to the image controller 64. In the meantime, the northbridge chip also transmits image data to the image controller 64. The image controller 64 receives the driving signal, starting to receive and process the image data. Then the processed data is sent to the mini-projector 30 for projection. Moreover, the notebook 1 further includes a display 20 and a video camera 40. The video camera 40 takes a picture and generates image data that is sent to the image controller 64 for being processed and then the processed image data is displayed on the display 20 or is projected by the mini-projector 30.

Furthermore, the notebook 1 further includes a second control chip 66, a modem 68, an audio device 70, a logic chip 72 and a port 74. The second control chip 66 is coupled to at least a peripheral device such as a hard disc drive (HDD) 660 and generates a control signal according to the peripheral device. The control signal is transmitted to first control chip 62. After receiving the control signal, the first control chip 62 sends the driving signal and image data to the mini-projector 30 so as to drive the mini-projector 30 to project the image data. The second control chip 66 is a southbridge chip. As to the central processing unit 60, it communicates with other system components such as the first control chip 62, the image controller 64, the second control chip 66, the modem 68, the audio device 70 and the logic chip 72. by a bus. The central processing unit 60 and memory system get access to various input/output peripheral devices. The bus 80 is a peripheral component interconnection bus (PCI Bus).

In addition, the notebook 1 further includes the port 74 that connects with external devices such as a keyboard or a monitor. The present invention further has a PC card host adapter 76 that get data inside memory cards 762, 764 by insertion of a first memory card 762 (PC-CARD-0) or a second memory card 764 4(PC-CARD-1). After being processed by the image controller 64, the data is sent to the mini-projector 30 for projecting the image data or is sent the display for displaying the image.

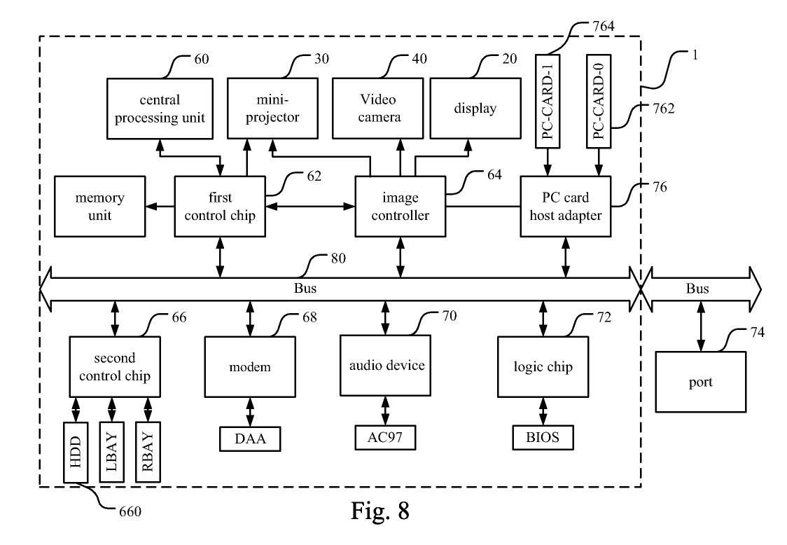

Refer to FIG. 8, the difference between this embodiment and the above one in FIG. 7 is in that the first control chip 62 is coupled to the mini-projector 30 so that the first control chip 62 sends the image data that is not processed by the image controller 64 to the mini-projector 30. Thus the processing speed of the notebook 1 is improved.

In summary, a notebook with a mini-projector according to the present invention includes a mini-projector disposed on top of a display while the display is standing over a mainframe for projecting an image data. Thus convenience of use us improved.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. A notebook with a mini-projector comprising:
a mainframe;
a display disposed on the mainframe and electrically connected with the mainframe; and
a mini-projector arranged on the display for displaying images.

2. The notebook as claimed in claim 1, wherein the mini-projector arranged on the display is on top of the display.

3. The notebook as claimed in claim 1, wherein the notebook further comprising:
a mounting space arranged on the display for disposition of the mini-projector; and
two rotation axes respectively arranged on two ends of the mini-projector, being inserted to right and left side walls of the mounting space.

4. The notebook as claimed in claim 1, wherein the notebook further comprising:
a mounting space arranged on the display for disposition of the mini-projector; and
two rotation axes respectively arranged on right and left side walls of the mounting space, being inserted to and assembled with the mini-projector.

5. The notebook as claimed in claim 1, wherein the mini-projector further comprising:
a main housing for accommodation of the mini-projector.

6. The notebook as claimed in claim 1, where the display further comprising:
a display housing including a connecting member, the connecting member connecting with the mainframe ; and
a display module mounting inside the display housing.

7. The notebook as claimed in claim 1, wherein the notebook further comprising:
a central processing unit generating a command signal; and
a first control chip receiving the command signal, and producing a driving signal.

8. The notebook as claimed in claim 7, wherein the notebook further comprising:
an image controller coupled with the first control chip, and sending the driving signal to the mini-projector for projection.

9. The notebook as claimed in claim 7, wherein the first control chip is a northbridge chip.

10. The notebook as claimed in claim 7, wherein the notebook further comprising:
a second control chip coupled with the first control chip and at least a peripheral device, and receiving a image data of the peripheral device, and sending the image data to the first control chip for producing the driving signal.

11. The notebook as claimed in claim 10, wherein the first control chip is a souththbridge chip.

12. The notebook as claimed in claim 10, wherein the peripheral device is a storage device.

13. The notebook as claimed in claim 8, wherein the transmission interface of the image controller is a peripheral component interconnection bus,(PCI Bus).

14. A notebook with a mini-projector comprising:
a mainframe;
a display disposed on the mainframe and electrically connected with the mainframe;
a mini-projector arranged on the display for displaying images; and
a video camera arranged on the display.

15. The notebook as claimed in claim 14, wherein the video camera and the mini-projector are arranged on the same side of the display.

16. The notebook as claimed in claim 15, wherein the notebook further comprising:
a first mounting space for disposition of the mini-projector;
a second mounting space for accommodation of the video camera; and
a plurality of axes respectively on two ends of the video camera and the mini-projector; the axes on two ends of the mini-projector are inserted to right and left side walls of the first mounting space while the axes on two ends of the video camera are inserted to right and left side walls of the second mounting space.

17. The notebook as claimed in claim 15, wherein the notebook further comprising:
a mounting space disposed on the display for disposition of the mini-projector; and
a plurality of axes respectively disposed on the mini-projector, the video camera and the mounting space.

18. The notebook as claimed in claim 14, wherein the video camera and the mini-projector are disposed on different sides of the display.
